(19) United States
(12) Patent Application Publication
(10) Pub. No.: US 2011/0026254 A1
(43) Pub. Date: Feb. 3, 2011

(54) METHOD AND APPARATUS FOR LIGHT SIMULATION IN A DESIRED SPECTRUM

(75) Inventors: YUQIANG LI, Xi'an (CN); Xiaohua Xu, Xi'an (CN)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/582,875

(22) Filed: Oct. 21, 2009

(30) Foreign Application Priority Data
Jul. 31, 2009 (CN) 200910160954.8

(51) Int. Cl. F21S 4/00; F23Q 23/08

(52) U.S. Cl. 362/249.07; 362/249.01; 445/3

(57) ABSTRACT

Embodiments of the invention provide an improved method and apparatus including a hybrid lamp array for use as a simulated light source and within a solar simulator tool. In one embodiment, a light source for simulating a desired spectrum comprises a first plurality of lamps of a first type configured in a first plane and a second plurality of lamps of a second type configured in a second plane, wherein the second plane is substantially parallel to the first plane, and wherein the distance between the first and second planes is adjustable to simulate the desired spectrum.

### BACKGROUND OF THE INVENTION

1. Field of the Invention

Embodiments of the present invention generally relate to methods and apparatus for providing a light source for testing and qualifying a photovoltaic device in a production line.

2. Description of the Related Art

Photovoltaic (PV) devices or solar cells are devices which convert sunlight into direct current electrical power. When thin film PV devices, or thin film solar cells, are exposed to sunlight (consisting of energy from photons), the sunlight is converted to electricity through the PV effect. Solar cells may be tiled into larger solar arrays by connecting a number of solar cells and joining them into panels with specific frames and connectors.

Conventional solar cell manufacturing processes are highly labor intensive and have numerous interruptions that can affect production line throughput, solar cell cost, and device yield. Typical solar cell qualification and testing devices utilize lamps that are configured to expose a PV device to a beam of light and probes to detect the current generated. The lamps are positioned above the substrate and configured to shine a beam of light downwardly toward the horizontally positioned PV device. Traditional light sources, such as xenon lamps, require use of an optical filter to filter out light having undesired wavelengths. As the demand for using increasingly larger substrates and higher production throughput continues to grow, the cost required for such testing and qualification hardware in fabrication facilities increases as well.

Therefore, there is a need for an apparatus that provides a simulated light source solution for testing and qualifying PV devices in a cost effective manner.

### SUMMARY OF THE INVENTION

Embodiments of the invention provide an improved method and apparatus including a hybrid lamp array for use as a simulated light source and within a solar simulator tool. In one embodiment, a light source for simulating a desired spectrum comprises a first plurality of lamps of a first type configured in a first plane and a second plurality of lamps of a second type configured in a second plane, wherein the second plane is substantially parallel to the first plane, and wherein the distance between the first and second planes is adjustable to simulate the desired spectrum.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of the invention and are therefore not to be considered limiting of its scope, for the invention may admit to other equally effective embodiments.

FIG. 1A is a schematic view of a light source according to one embodiment.

FIG. 1B is a schematic plan view of the light source depicted in FIG. 1A.

FIG. 2 illustrates data analysis of a simulated light source comparing a spectrum of a simulated light source against a spectrum of sunlight according to one embodiment.

FIG. 3 is a schematic drawing of a solar simulator module according to one embodiment.

FIG. 4 is a flow diagram of a method for matching a spectrum of a simulated light source to a spectrum of a desired light source according to one embodiment.

To facilitate understanding, identical reference numerals have been used, where possible, to designate identical elements that are common to the Figures. It is contemplated that elements disclosed in one embodiment may be beneficially utilized on other embodiments without specific recitation

### DETAILED DESCRIPTION

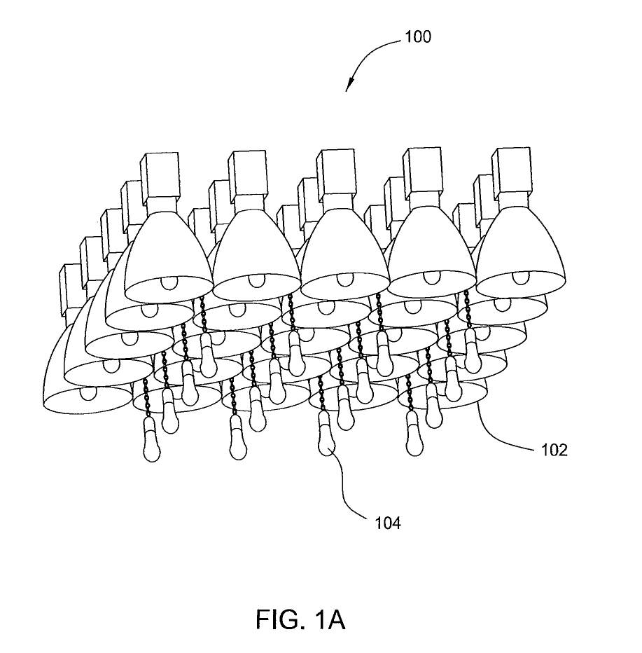

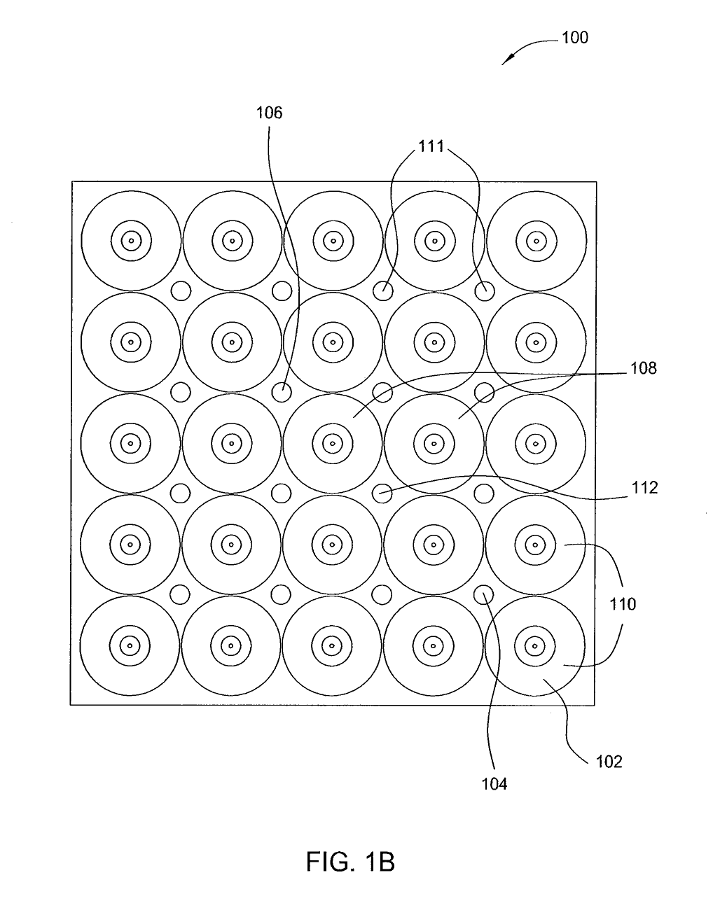

FIG. 1A is a schematic view of a light source 100 according to one embodiment. The light source 100 may be a mixture of two types of lamps consuming different levels of power arranged into a hybrid lamp array. The light source 100 comprises a first light source array 102 and a second light source array 104. The first light source array 102 may comprise a plurality of first lamps arranged in a number of rows and columns. The second light source array 104 may comprise a plurality of second lamps arranged in a number of rows and columns. The number of rows and columns for each of the first light source array 102 and the second light source array 104 may be adjusted according to the size of the photovoltaic (PV) device to be tested. In one embodiment, the first light source array 102 may include a lamp with a first power level, such as metal halide lamps. In one embodiment, the second light source array 104 may include a second lamp with a second power level, such as incandescence or tungsten lamps. In one embodiment, to achieve uniformed light distribution, the first light source array 102 is arranged in a first plane and the second light source array 104 is arranged in a second plane that is substantially parallel to the first plane. The distance between the first and the second planes may be adjusted accordingly to match desired spectrums. In one embodiment, the distance between the first and second planes may be adjusted manually or in an automated fashion by use of one or more actuators, such as a stepper motor or the like. In one embodiment, a desired spectrum may include a spectrum for sunlight.

FIG. 1B is a schematic plan view of the light source 100 according to one embodiment. The lamps for the first light source array 102 and the second light source array 104 are arranged in rows and columns. More specifically, to match the spectrum for a desired light, such as sunlight, each of the lamps in the second light source array 104 is surrounded by lamps in the first light source array 102, and each of the lamps in the first light source array 102 is surrounded by lamps in the second light source array 104. For example, lamp 106 of the second light source array 104 is positioned in the center of an interspace defined by four lamps in the first light source array 102. Lamp 108 of the first light source array 102 is positioned in the center of an interspace defined by four lamps in the second light source array 104. In one embodiment, lamps 110 in the outer row and the outer column of the first light source array 102 are configured in a third plane that is substantially parallel to the second plane. In this embodiment, the lamps 110 may be adjusted separately to compensate for lack of light output at the edge of the light source 100. For example, the lamps 110 at the outer row and column of the first light source array 102 may be adjusted to be closer to the PV device than the lamps 108 in the center of the first light source array 102. Similarly, lamps 111 in the outer row and outer column of the second light source array 104 are configured in a fourth plane that is substantially parallel to the first plane. In this embodiment, the lamps 111 may also be adjusted separately to compensate for lack of light output at the edge of the light source 100. Compared with the lamps 106 and 108, the lamps 110 and 111 may provide more illumination to the PV device being tested to make the light uniformly distributed across the PV device.

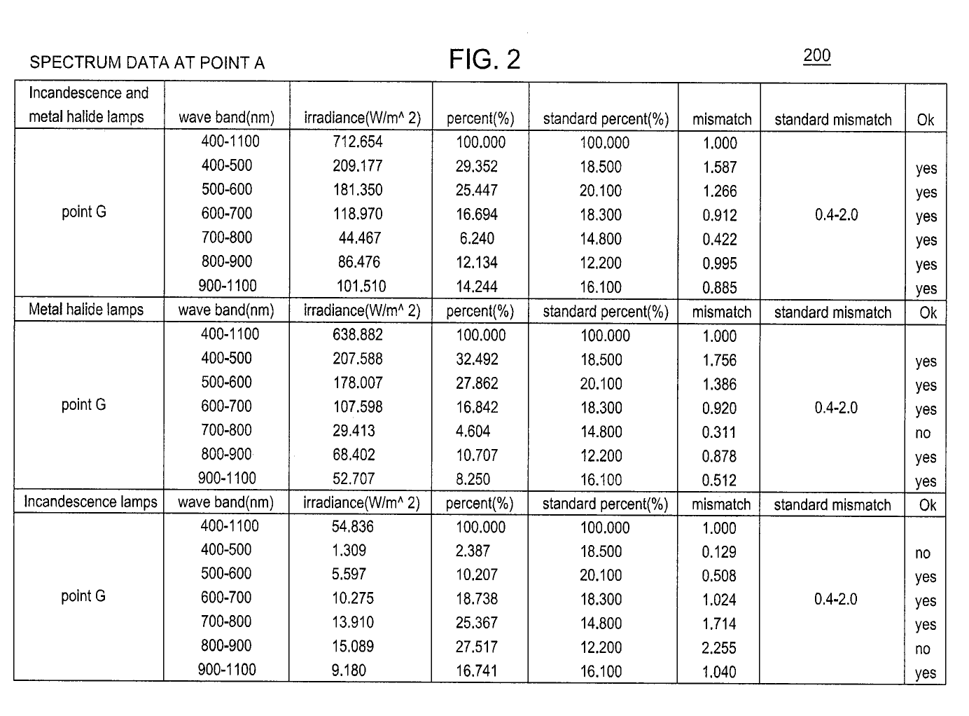

By surrounding the lamps 108 with a first power level in the first light source array 102 with the lamps 106 with a second power level in the second light source array 104, the light source 100 may be able to simulate a desired light source, such as sunlight. The lamps 108 of the first light source array 102 and the lamps 106 of the second light source array 104 may also compensate for each other during simulation to provide proper spectrum mismatch data. In conjunction with FIGS. 1A and 1B, FIG. 2 illustrates data analysis 200 of a simulated light source, such as the light source 100, comparing a first spectrum of the simulated light source against a second spectrum of a desired light source, such as sunlight. The data analysis is performed by comparing the first spectrum of the simulated light source against the second spectrum of sunlight. The second spectrum for sunlight is a known standard published by International Electrotechnical Commission (IEC). The analysis is performed by comparing a percentage of a measured irradiance in different wave bandwidth ranges of the simulated light source against a percentage in the standard spectrum for sunlight in the same range of wave bandwidth as published by IEC. The comparison of the percentage differences is called a mismatch. In some implementations, the standard mismatch for sunlight is from 0.4-2.0. To illustrate, the spectrum mismatch data shown in FIG. 2 is collected from a specific location, such as point A 112 in the hybrid lamp array of light source 100. The spectrum mismatch data measures wave bandwidth with ranges from 400 nm-1100 nm. The irradiance (W/m²) in each wave bandwidth range is measured. The percentage of the irradiance in each wave bandwidth range is calculated by dividing the irradiance measured in each wave bandwidth range by the total irradiance of all wave bandwidth (nm) ranges. For example, for a wave bandwidth ranging form 400 nm-500 nm, the irradiance is measured as 195.480 W/m². The percentage of the irradiance measured for the wave bandwidth of 400 nm-500 nm is obtained by dividing 195.480 W/m² by the total irradiance 748.911 W/m², which is 26.102%. The mismatch is calculated by dividing the 26.102% by the standard percentage of 18.5% published by IEC, and a result of 1.411 is obtained. The calculated mismatch of 1.411 falls between the standard mismatch of 0.4-2.0; therefore, the spectrum mismatch is satisfied. As the mismatch data in FIG. 2 illustrates, each spectrum mismatch of the different wave bandwidth ranges satisfies the standard mismatch; therefore, the first spectrum for the simulated light source corresponds with the second spectrum for sunlight.

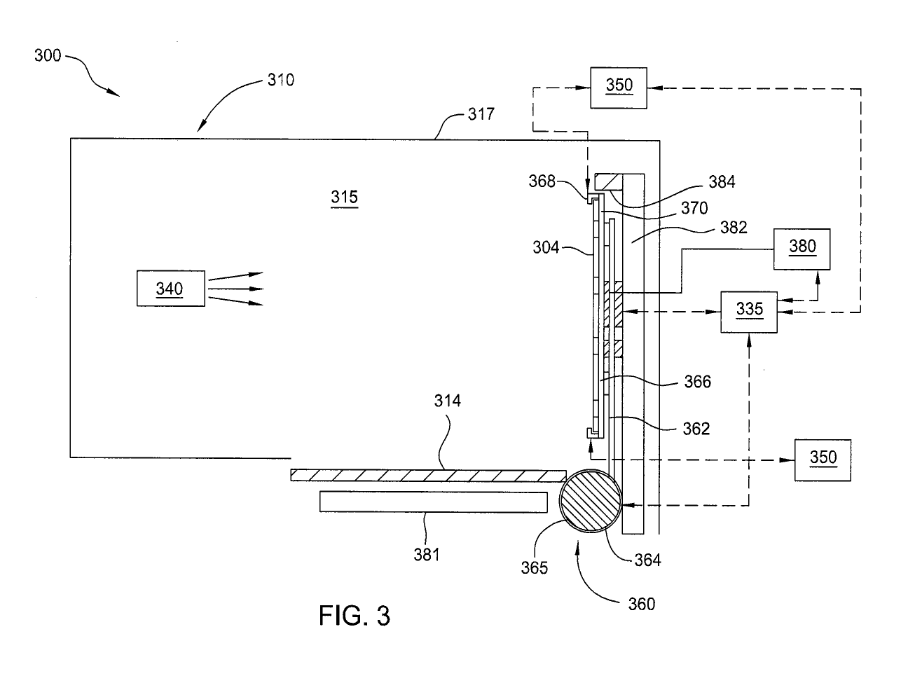

Embodiments described herein provide methods and apparatus for testing and qualifying a PV device. In one embodiment, a solar simulator module comprises a light source, a device support facing the light source, a probe positioned to make electrical contact with a substrate on the device support, and a high potential test frame comprising a plurality of contact segments mounted on actuators configured to retract and extend the contact segments. FIG. 3 is a schematic drawing of a solar simulator module according to one embodiment. The solar simulator module 300 comprises a positioning robot 360 and a device support 362 coupled to the positioning robot 360. The positioning robot 360 comprises a rotary actuator 364 and a rotary brake 365. The device support 362 comprises a gantry 370 and a plurality of support elements 366 positioned to retain a PV device 304 against the gantry 370. In one embodiment, the support elements 366 are vacuum gripping elements.

In one embodiment, the rotary actuator 364 comprises a motor for rotating the device support 362 from a substantially horizontal loading or unloading position to a substantially vertical processing position. The rotary brake 365 provides holding capability in the event power is lost during movement of the device support 362. In the loading or unloading position, the device support 362 interacts with a factory automation device 381 that moves PV devices 304 into and out of the module 300, lifting an untested PV device 304 off the automation device 381, and replacing a tested PV device 304 back onto the automation device 381.

The module 300 further comprises a support member 382 for positioning one or more probe devices 380. The probe devices 380 generally measure the response of the PV device 304 to electrical or radiant input. The one or more probe devices 380 generally comprise a probe nest for connecting to a connection point on the PV device 304. The connection point provides a configured connection between conductors disposed within the PV device 304 and external circuits. The probe devices 380 are located at a point on the module 300 to facilitate contact with connectors disposed or formed in the PV device 304. The one or more probe devices 380 may also comprise a high potential probe for applying high voltage to one or more of the connection points on the PV device 304. A high voltage may be applied to a connection point of the PV device 304 by coupling a power supply 335 to a high potential probe among the probe devices 380, and electrical sensors 350 may be coupled to a frame 368 disposed at an edge region of the PV device 304 to detect any current developed by the high voltage. The frame 368 may comprise a plurality of segments coupled to actuators for moving into a processing position or a loading and unloading position.

The module 300 further comprises an enclosure 310, which defines a processing space 315, in which the PV device 304 is disposed for processing. A solar spectrum source 340, such as the light source 100, is disposed in the processing space 315 for directing solar spectrum energy toward the PV device 304. The enclosure 310 comprises a wall 317 and a door 314. The door 314 may be retracted to allow the device support 362 to access the automation device 381 through an opening in the wall 317. The rotary actuator 364 rotates the device support 362 through the opening in the wall 317 into position to contact a PV device 304 on the automation device 381. The rotary actuator 364 then rotates the device support 362 through the opening in the wall 317 into the processing space 315 to a substantially vertical test position. The door 314 closes to exclude any extraneous light from the module 300.

In one embodiment, one or more reference cells 384 may be attached to the vertical support member 382 to receive light from the solar spectrum source 340. The reference cell 384 may be used to monitor and control the output of the solar spectrum source 340. In one embodiment, a plurality of reference cells 384 may be used to account for different p-n junctions in a multiple junction solar cell device. In one embodiment, one reference cell 384 may be configured to absorb an overall light spectrum, another reference cell 384 may be configured to absorb light solely in the red spectrum, and yet another reference cell 384 may be configured to absorb light solely in the blue spectrum.

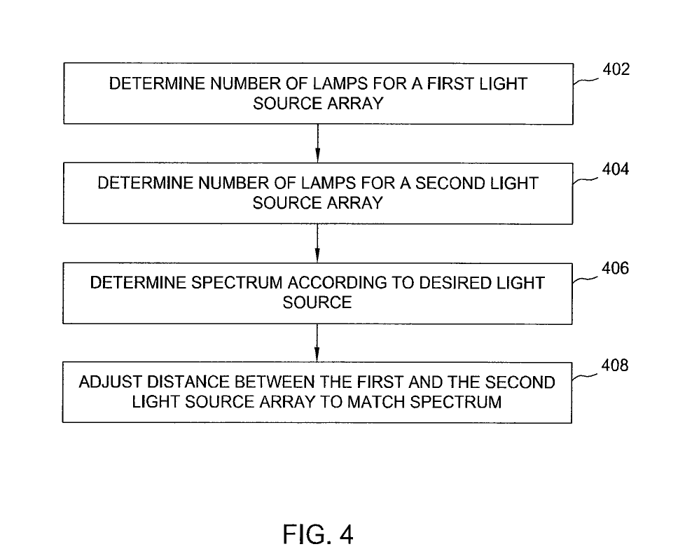

FIG. 4 is a flow diagram of a method for matching a spectrum of a simulated light source, such as the light source 100, to a spectrum of a desired light source according to one embodiment. The method of FIG. 4 is useful for determining the proper spectrum for a simulated light source to be tested on a PV device. In step 402, the number of lamps for a first light source array, such as the first light source array 102, is determined. In step 404, the number of lamps for a second light source array, such as the second light source array 104, is determined. The number of lamps for the first light source array and the second light source array may be determined depending on the size of the PV device to be processed. In one embodiment, the size of the PV device may include a length of approximately 2.6 meters and a width of approximately 2.2 meters. After the number of lamps for the first and second light source arrays has been determined, in step 406, the spectrum for a desired light source is determined. In one embodiment, the desired light source may be sunlight. In step 408, the distance between the first light source array and the second light source array is adjusted until spectrum of the simulated light source matches the spectrum of the desired light source.

While the foregoing is directed to embodiments of the invention, other and further embodiments of the invention may be devised without departing from the basic scope thereof.

1. A light source for simulating a desired spectrum, comprising:
a first plurality of lamps of a first type configured in a first plane; and
a first plurality of lamps of a second type configured in a second plane, wherein the second plane is substantially parallel to the first plane, and wherein the distance between the first and second planes is adjustable to simulate the desired spectrum.

2. The light source of claim 1, wherein each lamp of the second type is surrounded by lamps of the first type.

3. The light source of claim 2, wherein each lamp of the first type consumes a first level of power and each lamp of the second type consumes a second level of power.

4. The light source of claim 3, wherein each lamp of the first type is a metal halide lamp and each lamp of the second type is an incandescence or tungsten lamp.

5. The light source of claim 2, further comprising a second plurality of lamps of the first type configured in a third plane substantially parallel to the second plane, wherein the second plurality of lamps of the first type surround the first plurality of lamps of the first type and the first plurality of lamps of the second type.

6. The light source of claim 5, wherein the distance between the third plane and the first plane is adjustable.

7. The light source of claim 5, further comprising a second plurality of lamps of the second type configured in a fourth plane substantially parallel to the first plane, wherein the second plurality of lamps of the second type surround the first plurality of lamps of the first type and the first plurality of lamps of the second type.

8. The light source of claim 7, wherein the distance between the fourth plane and the first plane is adjustable.

9. A solar simulator module, comprising:
a light source comprising a first plurality of lamps of a first type configured in a first plane and a first plurality of lamps of a second type configured in a second plane, wherein the second plane is substantially parallel to the first plane, and wherein the distance between the first and second planes is adjustable;
a device support facing the light source;
a probe positioned to make electrical contact with a device positioned on the device support; and
a high potential test frame comprising a plurality of contact segments mounted on actuators configured to retract and extend the contact segments.

10. The module of claim 9, wherein each lamp of the second type is surrounded by lamps of the first type.

11. The module of claim 10, wherein each lamp of the first type consumes a first level of power and each lamp of the second type consumes a second level of power.

12. The module of claim 11, wherein each lamp of the first type is a metal halide lamp and each lamp of the second type is an incandescence or tungsten lamp.

13. The module of claim 10, further comprising a second plurality of lamps of the first type configured in a third plane parallel to the second plane, wherein the second plurality of lamps of the first type surround the first plurality of lamps of the first type and the first plurality of lamps of the second type.

14. The module of claim 13, wherein the distance between the third plane and the first plane is adjustable.

15. The module of claim 13, further comprising a second plurality of lamps of the second type configured in a fourth plane substantially parallel to the first plane, wherein the second plurality of lamps of the second type surround the first plurality of lamps of the first type and the first plurality of lamps of the second type.

16. The module of claim 15, wherein the distance between the fourth plane and the first plane is adjustable.

17. A method of making a light source for simulating a desired spectrum, comprising:
arranging a first plurality of lamps of a first type in a first plane;
arranging a first plurality of lamps of a second type in a second plane substantially parallel to the first plane;
adjusting the distance between the first plane and the second plane to obtain the desired spectrum.

18. The method of claim 17, further comprising arranging the first plurality of lamps of the second type such that each lamp of the second type is surrounded by lamps of the first type.

19. The method of claim 18, further comprising arranging a second plurality of lamps of the first type in a third plane surrounding the first plurality of lamps of the first type and the first plurality of lamps of the second type, wherein the third plane is substantially parallel to the second plane.

20. The method of claim 19, further comprising adjusting the distance between the second plane and the third plane to obtain the desired spectrum.

21. The method of claim 19, further comprising arranging a second plurality of lamps of the second type in a fourth plane surrounding the first plurality of lamps of the first type and the first plurality of lamps of the second type, wherein the fourth plane is substantially parallel to the first plane.

22. The method of claim 21, further comprising adjusting the distance between the first plane and the fourth plane to obtain the desired spectrum.
